(19) United States
(12) Patent Application Publication
(10) Pub. No.: US 2003/0095848 A1
(43) Pub. Date: May 22, 2003

(54) Load indicating fastener insert

(76) Inventor: Ronald C. Clarke, Phoenix, AZ (US)

Correspondence Address: Patrick L. Mixon, One Arizona Center, 400 E. Van Buren, Phoenix, AZ, 85004-2202, US

(21) Appl. No.: 09/992,871

(22) Filed: Nov. 16, 2001

(51) Int. Cl. F16B 31/02

(52) U.S. Cl. 411/14

(57) ABSTRACT

A method and apparatus for determining fastener axial loading includes a fastener insert having an arched bottom surface, which deflects correlative to the level of axial loading. A load indicating apparatus determines axial loading by measuring the amount of deflection experienced by the arched bottom surface of the insert. In addition, the arched insert stores elastic energy which is added to the overall elastic energy of the fastener, thereby aiding the fastener integrity during use.

### BACKGROUND OF THE INVENTION

1. Field of the Invention

This invention generally relates to load indicating fasteners, and more particularly, to a low profile load indicating and energy storing device adapted to visually indicate the load in a fastener.

2. Description of the Related Art

Fasteners are used in a wide variety of applications, such as motors, railroad tracks, flange assemblies, petrochemical lines, foundations, mills, drag lines, power turbines and studs on cranes and tractors. As is known in the use of such fasteners, as force is applied to a portion of the fastener, e.g. a head of a bolt or the like, the fastener experiences a strain described as the fastener load. As the fastener is tightened, this load increases to a maximum break point, where the fastener breaks or its integrity is otherwise compromised. Therefore, it is desirable that applied fasteners should be properly tightened to design load levels in order to ensure that secure joints are achieved without compromising the fastener viability. In many applications, however, achieving the proper fastener tightness and maintaining this tightness once the system is placed in service is problematic. For various applications, optimal loads are known and/or are obtainable, but currently available methods and apparatus do not adequately enable reliable and repeatable determinations thereof.

During use, fasteners typically experience a loss of tension e.g. tightness, due to, for example, a variety of in-service occurrences including: relaxation (thread embedment), vibration loosening, compressive deformation in the joint or flange, temperature expansion or contraction, etc. The loss of tension that results from these occurrences can cause premature wear in the assembly, leakage (in applications where the fastener is used for sealing), or critical joint failure due to excessively high loads on other members of the assembly. Such potential failures are catastrophic in systems where premature wear, leakage or joint failure may result in loss of life.

An apparatus and method is therefore needed which permits the accurate tightening of a fastener to optimal load levels and which permits the determination the existing fastener load status.

It is well known that indicated tensile strain gives a true representation of the load induced in a fastener. Various prior art tensile strain indicators may concentrate on the tensile strain of the individual members of the fastener, such as for example, the fastener washer. One such indicator is described in U.S. Pat. No. 6,250,863, issued to Kamentser et al., which purportedly discloses a washer having a plurality of strain gauges integrated into the body of the washer. The Kamentser patent discloses two sets of strain gauges, at least one of which is positioned on a portion of the washer subjected to axial force, and at least one of which is positioned on a portion of the washer not subjected to axial force. The strain gauges are connected into a common bridge circuit which purportedly provides a signal indicating the axial stress applied to the washer body.

Several problems, however, are associated with the fasteners described in the Kamentser patent. For example, in most instances it is cost prohibitive to integrate the electrical measuring devices into the body of each individual washer. Additionally, the integrated instrumentation, which are placed in the body of the washer, compromises the overall integrity of the fastener and is thus not suitable for applications using fasteners in a rugged environment.

Thus, a need exists for a device which measures tensile strain, is not cost prohibitive, and which additionally does not compromise the overall fastener integrity when used in a rugged environment.

Other prior art systems avoid the problems inherent in using integrated electrical components and instrumentation by using mechanical load indicators. For example, UK Patent Number GB-2-179-459-A, issued to Ceney, discloses an externally mounted mechanism for indicating the tightness of a fastener. This system includes a pin positioned in the bore of the fastener that extends out of the fastener end. Upon extension of the bolt, the pin applies pressure to fulcrumed levers positioned perpendicular to the axis of the bolt. The levers, which are acted upon by a compression spring, are then visible through a window cover for visually inspecting washer load levels.

Due to the complex arrangement of the levers, and position of the indicator window inherent in the design of this system, the indicator components typically must be positioned on the outside of the bolt. Since the indicator components are rather bulky relative to the washer, the use of the Ceney system is often not possible in fastener environments having space constraints. In cases where it is possible to use such a configuration, the elements of the instrument may be susceptible to outside forces and damage. Upon damage, no convenient method exists to verify whether the unit may still be calibrated.

Therefore, a need exist for a load indicating system which conforms to the space limitations of a fastener environment, and which includes means for readily identifying when the load indicator is not valid or the fastener is not at its desired load level.

It should be further noted that one of the main indicators of efficient clamp retention in a joint is the amount of elastic energy the bolt and other joint members can absorb. Regardless of the tightening technique used, when a bolt in a bolted joint is tightened, the bolt stretches elastically and stores energy. In this manner, the bolt acts as a spring and the stored energy facilitates the holding of the joint together at a specified load level.

To ensure that a fastener includes the highest amount of elastic energy, fastener designers typically focus on the grip length of the bolt used in the system. It is well known that the longer the grip length of a bolt, the more the energy the bolt will store in the fastener system. Consequently, a longer bolt having a longer grip length, will be able to store more elastic energy than a shorter bolt having a shorter grip length. Thus, the increased grip length of a longer bolt makes using the longer bolt in a fastener more preferable than using the shorter bolt. This is true because, the increased energy stored in the longer bolt is advantageous in that it enhances the integrity of the joint making the joint more tolerable to loosening or failure due to in-service loading.

However, in many fastener systems the use of the longer bolt is prohibited by space limitations, requiring the system to use a shorter bolt. As noted, because of the shorter grip length, the shorter bolt stores less elastic energy than the longer bolt, which makes the fastener more susceptible to loosing or failure. It is well known, however, that the grip length of the shorter bolt can be made longer, through the use of washers or sleeves which cause the shorter bolt to elastically stretch further and store more energy.

Unfortunately, the bolt's shorter length puts an upper limit on the number of washers which may be used to increase the shorter bolt's grip length. This, in turn, means that, in general, a shorter bolt may only be made to store a limited amount of elastic energy to aid in holding the joint together. Therefore, where, as in many instances, there are space constraints requiring the use of the shorter bolt, a fastening system may be used which results in poorly designed joints, since the shorter bolt may store an inadequate amount of energy. This poor grip length bolt diameter-to-length ratio may inevitably lead to joint loosening or failure.

A fastener system is therefore desired which would allow use of a shorter bolt while not compromising the amount of energy which may be stored in the fastener when a longer bolt is used. Such a fastener system may include the storage of additional elastic energy above that already stored in the bolt, and may additionally increase the effective grip length of the shorter bolt improving the fastener clamp retention property.

Consequently, presently known fasteners employing load indicators remain inadequate, particularly since these fasteners typically incorporate integrated electrical components, complex designs and/or are subject to loss of effectiveness do to loss of calibration or elastic energy over extended use. A need, therefore, exists for a load indicating fastener system which avoids the problems inherent in the prior art while providing an accurate reading of the tensile strain, e.g., load, being placed on the fastener system, and which stores additional energy allowing for the effective use of shorter bolts in a particular fastener system.

### SUMMARY OF THE INVENTION

The present invention provides a load indicating fastener system which addresses many of the shortcomings of the prior art. In accordance with various exemplary aspects of the present invention, a load indicating fastener insert is provided which stores elastic energy and which uses a load indicating system allowing visual indication of the load level of the fastener system with relative ease. It should be noted that while the following description is of a load indicating washer, the present invention is not so limited. That is, any fastener component which indicates fastener load and/or stores energy in accordance with the following description is contemplated to be within the scope of this invention. Consequently, while the following description is of a load indicating washer, the washer is merely illustrative of any suitable fastener insert or sleeve which may be used as a part of a fastening system. As such, the terms washer, fastener insert, and joint may be used interchangeably for the purposes of the description and claims provided herein.

In accordance with one exemplary embodiment of the present invention, a load indicating system may include a washer configured to store elastic energy during use. Such stored elastic energy may be added to the elastic energy of the fastener bolt thereby increasing the overall stored elastic energy of the fastener system. By increasing the amount of elastic energy in the fastener system, the washer may increase the fastener integrity and minimize the requirement that a longer bolt be used. In particular, the washer may store elastic energy such that the effective grip length of a shorter bolt is increased, allowing use of a shorter bolt in fastening applications where space is limited. A particular washer in accordance with this invention may include an arched bottom surface which allows the washer to deflect downward upon application of an axial load. The downward defection (“dishing”) which occurs permits the washer to act as a spring storing elastic energy. The stored elastic energy in the washer may be added to the overall elastic energy of the fastener system, thereby aiding in increased joint integrity.

In accordance with another exemplary embodiment of the invention, the load indicating system uses a load indicating plate affixed at opposing ends of the washer front surface, and a load indicator positioned substantially central to the opposing ends of the indicator plate. The placement of the indicating plate is such that the ends of the plate undergo negligible movement do to the axial force placed on the centroid of the washer upper surface. As noted, when an axial force is applied to the washer, the washer experiences a dishing. The dishing, which is correlative to the amount of the applied axial load, may be measured by the system load indicator. The load measurement may then be determined by visual inspection of the load indicator. Consequently, the desired load amounts may be achieved by loading the washer to a corresponding deflection as measured by the load indicator. Once the load is removed, the elastic energy contained in the washer is released and the washer returns to its original unloaded position, wherein the load indicator visually indicates that no load is present.

In yet another exemplary embodiment, the load indicator system of the present invention may include a load indicating scale comprising a load indicating pointer, and at least a main drive gear and a pinion gear configured to translate the axial load applied to the washer centroid into a measurable quantity. As the axial load is applied, the deflection of the washer drives the main and pinion gears causing the load indicating pointer to rotate along the load indicating scale. The location of the pointer along the scale gives visual indication of the amount of applied load. In another exemplary embodiment, the load indicator system may include additional gears as required to translate minimum dishing to a measurable axial load. In yet another exemplary embodiment, the load indicator system uses an outer plate to shield the gear arrangement from contacting outer forces.

In accordance with still another exemplary embodiment in accordance with the present invention, a load set pointer may be used to indicate the initial axial loading position of the washer. The load set pointer may move to a desired load position upon initial axial loading and remain fixed at the initial loading position, such that when the aforementioned load indicating pointer moves due to washer unloading, relaxation, deformation, expansion, contraction or the like, such movement from the initial loading position can be easily detected upon casual visual inspection.

In still another exemplary embodiment, the load indicator system may include an immovable load indicator, comprising an immovably affixed deflection indicator, an adjustable load indicating pointer positioned within the immovably affixed deflection indicator, and a load indicating feeler gauge. Before axial loading, the adjustable load indicating pointer is adjusted to indicate “zero” loading of the washer. Once an axial load is applied, the washer body deflects correlative to the amount of axial loading. The system user may then use the load indicating feeler gauge to determine the amount of axial loading on the washer, by measuring the amount of deflection with respect to the load indicating pointer.

In yet another exemplary embodiment the load indicator may include transducers (e.g., displacement or pressure transducer, etc.) capable of being coupled to a portable visual load indicator, for translating the transducer signal into a readable value representing axial load levels. The axial load on the washer, and the associated washer strain, may be detected by the transducer and correlated into an electrical signal readable by the portable visual load indicator, which in turn, gives a visual reading of the amount of axial load present. The portable visual load indicator may include an electrical output device or mechanical output device which presents the transducer signal to be read in accordance with the fastener axial load.

### BRIEF DESCRIPTION OF THE DRAWINGS FIGURES

A more complete understanding of the present invention may be derived by referring to the various exemplary embodiments of the present invention which are described in conjunction with the appended drawing figures in which like numerals denote like elements, and in which:

FIG. 1A depicts an exemplary washer in accordance with an exemplary embodiment of the present invention;

FIG. 1B depicts a bottom view of an exemplary washer in accordance with an exemplary embodiment of the present invention;

FIGS. 2A depicts another exemplary washer in accordance with an exemplary embodiment of the present invention;

FIG. 2B depicts a first side view of an exemplary washer in accordance with an exemplary embodiment of the present invention;

FIG. 2C depicts a second side view of an exemplary washer in accordance with an exemplary embodiment of the present invention;

FIG. 2D depicts a bottom view of an exemplary washer in accordance with an exemplary embodiment of the present invention;

FIG. 3A depicts an exemplary indicator plate in accordance with an exemplary embodiment of the present invention;

FIG. 3B depicts an exemplary washer and indicator plate in accordance with an exemplary embodiment of the present invention;

FIG. 4A depicts another exemplary embodiment in accordance with the present invention using at least a three gear arrangement;

FIG. 4B depicts another exemplary embodiment of a load indicating pointer in accordance with the present;

FIG. 4C depicts an exploded view of an exemplary embodiment of a washer and indicator plate in accordance with the present invention using at least a three gear arrangement;

FIG. 5A depicts another exemplary indicator plate in accordance with an exemplary embodiment of the present invention;

FIG. 5B depicts an exemplary feeler gauge in accordance with an exemplary embodiment of the present invention;

FIG. 5C depicts another exemplary washer and indicator plate in accordance with an exemplary embodiment of the present invention;

FIG. 6 depicts another exemplary embodiment in accordance with the present invention, wherein a transducer is used to translate an axial load to a readable electrical signal indicating washer load level;

FIG. 7A shows an exemplary load/deflection relationship of an exemplary washer in accordance with an exemplary embodiment of the present invention; and

FIG. 7B shows another exemplary load/deflection relationship of an exemplary washer in accordance with an exemplary embodiment of the present invention.

### DETAILED DESCRIPTION OF VARIOUS EXEMPLARY EMBODIMENTS

The following descriptions are of exemplary embodiments of the invention only, and are not otherwise intended to limit the scope, applicability or configuration of the invention. Rather, the following description is intended to provide a convenient illustration for implementing various embodiments of the invention. As will become apparent, various changes may be made in the function and arrangement of the elements described herein without departing from the spirit and scope of the invention. For example, though not specifically described, various shapes and orientations of the washer, indicator plate, the load indicator, and combinations thereof should be understood to fall within the scope of the present invention.

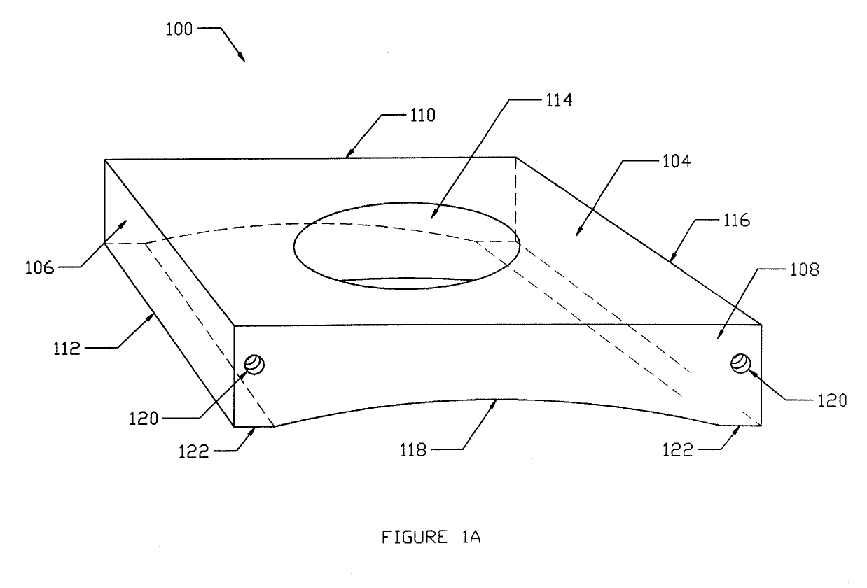

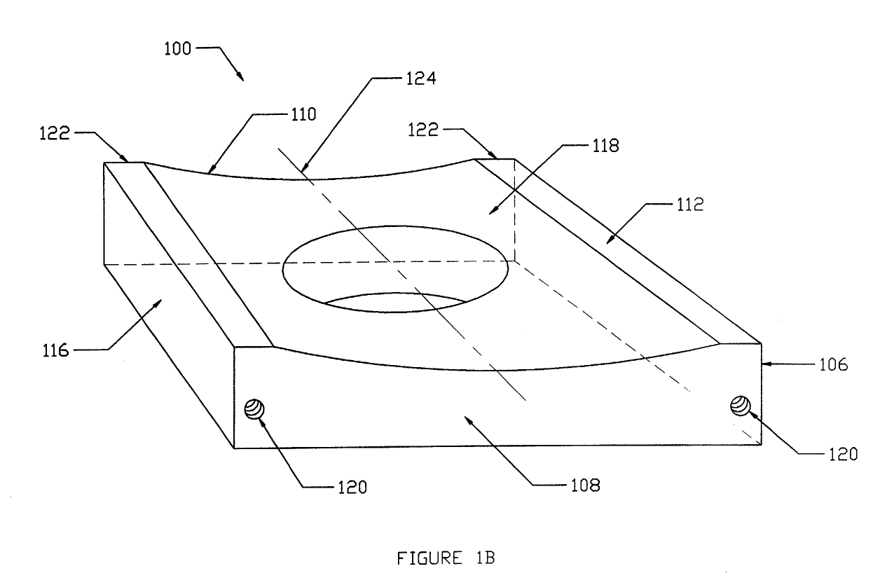

With reference to FIGS. 1A and 1B, what is shown is an exemplary embodiment of a washer 100 for use with this invention. As can be seen, washer 100 may be substantially rectangular in shape. It should be noted that although the washer 100 is depicted as substantially rectangular, other washer shapes may be suitable for use with the present invention. For example, washer 100 may be oblong, elliptical, polygonal, or any such shape wherein the washer 100 includes a substantially stationary edge, is capable of dishing and/or includes an axial bore for receiving a fastening means (e.g., bolt). In particular, washer 100 may comprise a substantially flat upper surface 104, a front side surface 108, a rear side surface 110, a left side surface 106 and a right side surface 116, where the aforementioned side surfaces are perpendicular to the flat upper surface 104. Washer 100 further includes a central bore 114 formed axially to the washer 100 centroid for use in inserting a load producing fastener such as a bolt, or pin, or the like (not shown).

FIG. 1B shows a bottom view of washer 100, wherein it can be seen that the bottom surface 112 of washer 100 is formed substantially parallel to upper surface 104. In addition, bottom surface 112 is configured such that the outer portions 122 of the bottom surface 112 of washer 100 are elevated from the center axis 124 of the bottom surface 112 of washer 100. For example, in the presently described embodiment, bottom surface 112 includes a spherical portion 118, e.g. an arc, where arc 118 is formed such that arc 118 is included in washer bottom surface 112 from washer front side surface 108 to washer rear side surface 110. The arc 118 may be characterized by a radius chosen to ensure that the washer upper surface 104 may deflect downward relative to the axial loading applied at the washer centroid. In this way, the dimensional characteristics of the washer 100 (e.g., washer thickness, length, width, and radius of the arc 118) may be chosen such that a desired deflection of the washer 100 may be measured relative to the amount of applied axial loading.

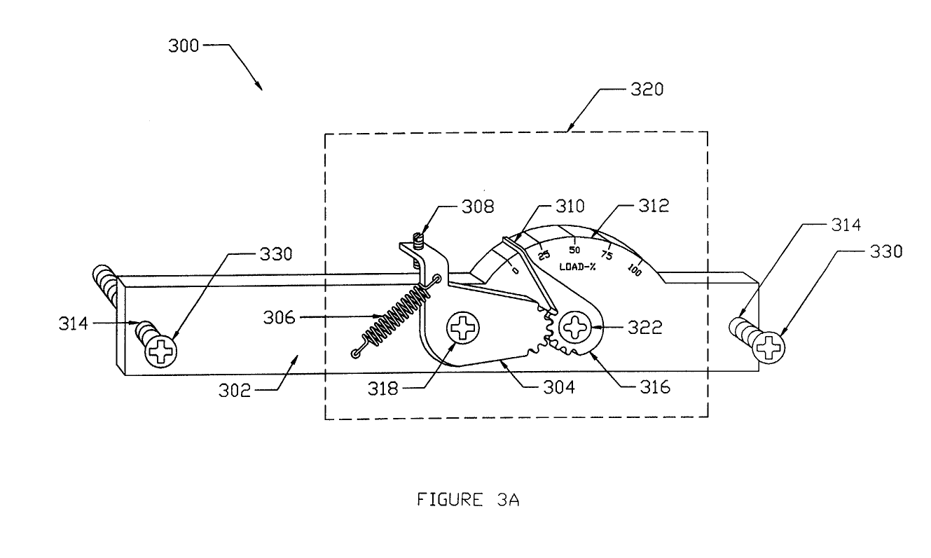

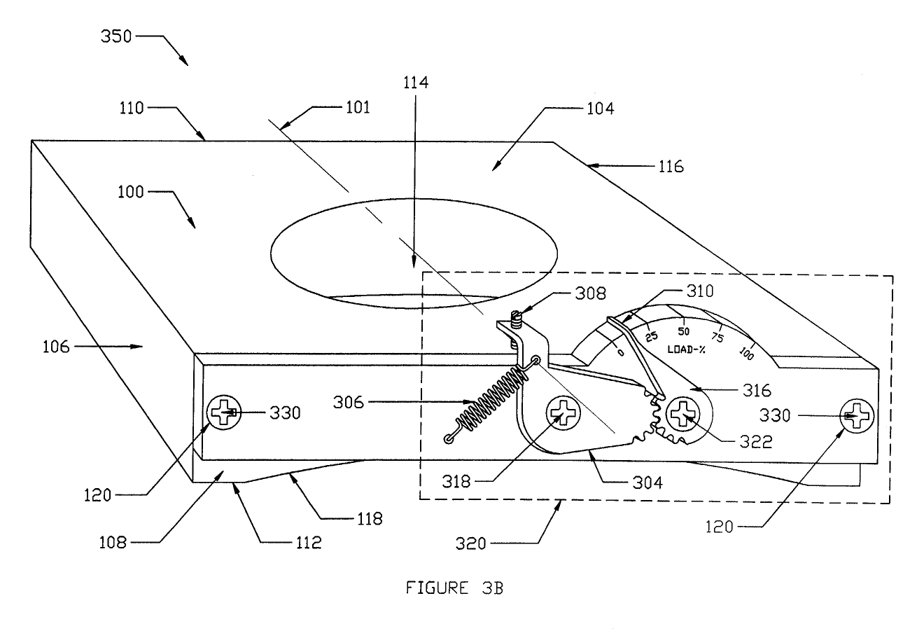

The front surface 108 further includes front bore holes 120 for use in affixing to washer 100 a load indicator plate system as described more fully below. Front bore holes 120 may be any suitable configuration for use in affixing a front indicator plate system 300 as shown in FIG. 3A. For example, where the indicator plate system is affixed using conventional screw structures, front bore holes 120 may be threaded.

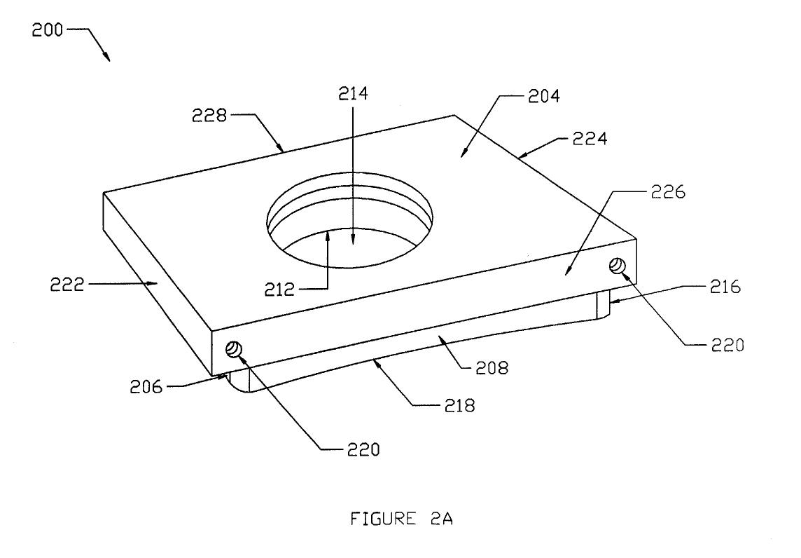

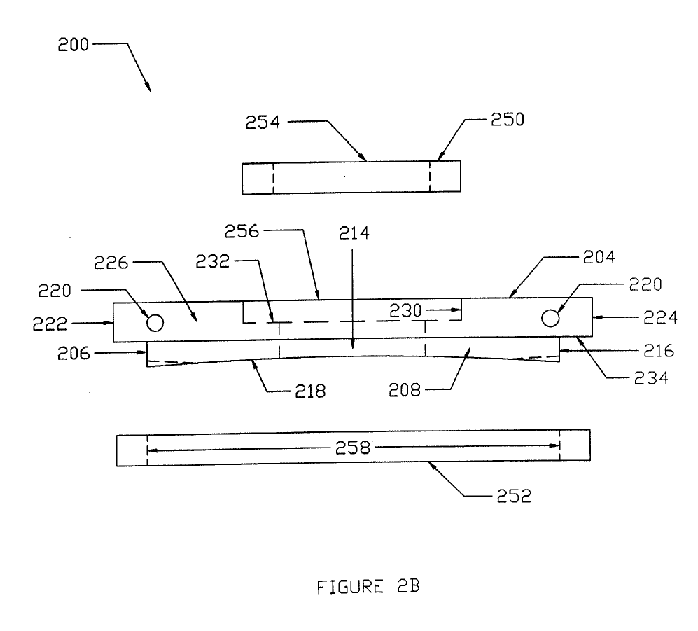

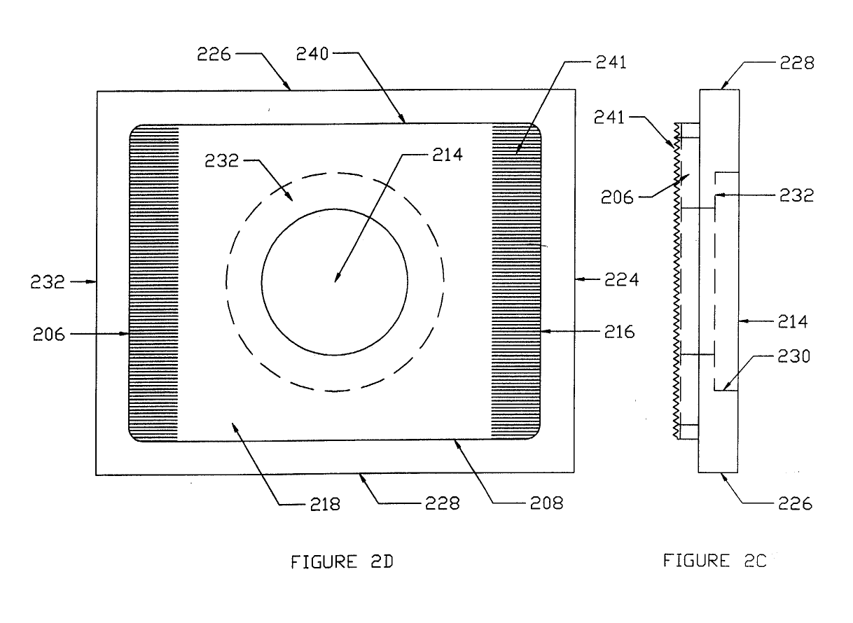

FIGS. 2A-2C show another exemplary embodiment of a washer 200 in accordance with the present invention. As shown, washer 200 is substantially rectangular in shape, including a substantially flat upper surface 204 which further includes a central bore 214 formed axially to the washer centroid in substantially the same manner as was described with respect to bore 114 of washer 100. Washer 200 further includes a front surface 226, rear surface 228, and side surfaces 222 and 224 each perpendicular to the upper surface 204. Washer 200 further includes an arc 218 of similar description as arc 118 of washer 100.

In accordance with this exemplary embodiment, washer 200 may be used in any application wherein various circular and/or rectangular seals may be required. As such, washer 200 may be configured to accommodate any such seals. For example, where a circular seal 250 is required to be fitted around a fastener (e.g., bolt) inserted at central bore 214, central bore 214 may be formed such that the circular seal 250 containing a central aperture 254 for insertion of the bolt may be inserted or fitted into the upper surface 204 of the washer 200. Similarly, where a rectangular seal 252 is required, washer 200 bottom may be configured such that the rectangular seal may be positioned circumspect to the washer bottom portion defined by bottom portion front surface 208, bottom portion rear surface 240 (shown in FIG. 2C), and bottom portion side surfaces 206 and 216. The construction and operation of typical seals for use with industrial washers are commonly known and, as such, the seals will not be described herein in detail. With reference to FIGS. 2A-C, what is shown is an exemplary embodiment of washer 200 formed to accommodate the aforementioned circular and rectangular seals.

With reference to FIG. 2B, what is shown is a washer 200 including a circular recess 256 to accommodate a circular seal 250 configured to fit circumferentially around a bolt-like fastener in the manner described above. In particular, central bore 214, may include a circular recess 256 centrally positioned to the axis of central bore 214 and configured to receive the circular seal 250. The circular recess 256 may be formed by a circular wall 230 running circumferentially to the axis of central bore 214 and perpendicular to the washer upper surface 204. The diameter of circular wall 230 may be larger than the outer diameter of the circular seal 250. In addition, the depth of the circular wall 230 may be such that the circular seal 250 may be inserted into the circular recess 256 wherein it may come to rest on a recess bottom 232 drawn radially to the circular wall 230. It should be understood then, that when a circular seal 250 is inserted into the circular recess 256, a fastener such as a bolt may be freely inserted into the central bore 214 opening to protrude out the washer bottom surface 212, without obstruction.

With further reference to FIG. 2B, the bottom surface 212 of washer 200 may be formed to accept a rectangular seal when required. As shown, the width and length of bottom surface 212 is chosen such that the perimeter of the bottom surface 212 is smaller than the inner perimeter 258 of the rectangular seal 252 allowing the rectangular seal 252 to be fitted over the bottom surface 212 without inhibiting the use of a fastener such as a bolt.

With reference to FIGS. 2C and 2D, another exemplary embodiment of a washer 200 in accordance with the present invention is shown, including serrations 240 on the outer edges of the bottom surface 212 and positioned parallel to arc 218. Such serrations 240 may be included in the washer 200 design, wherein it may be necessary to minimize washer 200 movement during loading of the washer 200.

It should be noted that the dimensions of washers 100 and 200 may be chosen as required by the particular application in which they are used. For example, the length, width and depth of the washer may be chosen to accommodate space considerations. Further, washers 100 and 200 may be of any material capable of withstanding the load required for a particular application. For example, washers 100 and 200 may be constructed of various steel and steel alloys as required. Moreover, washer dimensions and material considerations may be contemplated to configure larger or smaller washers, or washers using lighter or heavier graded materials, as a particular fastening application may require. Further still, while the exemplary washer embodiment shown in FIGS. 2A-2D include variations suitable for accommodating circular and rectangular seals and serrations to minimize washer 200 movement, it should be understood that the embodiment is exemplary of a washer capable of receiving such seals. That is, washer 200 may be configured to accept at least one of the seals or none of the seals as the application requires, and further may be configured with or without the noted serrations.

Turning now to FIGS. 3A and 3B what is shown is an exemplary indicator plate system 300 and load indicating washer system 350 in accordance with the present invention. It should be noted that systems 300 and 350 depicted are merely exemplary embodiments in accordance with the present invention, and as such, is not to be otherwise limiting. That is, one skilled in the art will realize that other embodiments including gearing systems, as described more fully below, may be used and are therefore within the scope of the invention. Further, it should be understood that while systems 300 and 350 are described with respect to washer 100, the invention is not to be so limited. That is, the systems 300 and 350 may be described with reference to any washer falling within the scope of the present invention.

With reference to FIG. 3A, load indicator plate system 300 preferably includes an indicator plate 302 including bore holes 314 at opposing ends of the indicator plate 302 for accepting a fastener 330 for affixing the indicator plate 302 to a washer 100 (described more fully with respect to FIG. 3B). Load indicator plate system 300 further includes a deflection indicator 320 positioned substantially central to the indicator plate 302 opposing ends. In addition, deflection indicator 320 includes a load indicating gauge 312, a main drive gear 304 affixed to the indicator plate by a fastener 318. Main drive gear 304 further includes a zero adjustment screw 308, positioned so that it may be adjusted to come in contact with washer surface 104 during operation of the load indicator system 300. Also included in system 300 is a spring 306 which forces the main drive gear 304, and it's adjustment screw 308, to stay in contact with the top surface of washer 104 as it deflects due to axial loading of the washer 100. The deflection indicator 320 further includes a pinion gear 322 meshed with the main drive gear 304 such that main drive gear 304 forcibly drives pinion gear 322 during operation, and wherein the pinion gear 322 is fastened to load indicator plate 302 via a suitable fastener 322. In addition, the pinion gear 322 further includes a load pointer 310, for indicating (e.g., pointing to) a loading position on gauge 312.

It should be noted that fasteners 318 and 322 may be affixed to load indicator plate 302 such that main drive gear 304 and pinion gear 316 may rotate freely. Further, the retention spring 306 may be of any conventional tension spring construction and may be affixed to indicator plate 302 at one end and to the main drive gear 304 at the opposite end, such that when washer 100 experiences deflection under loading conditions, the preloaded retention spring 306, through adjustable screw 308, remains in contact with the washer surface 104 and drives indicator 310 to a higher value, is limited by the degree of deflection of washer 100.

The operation of the load indicator plate system 300 in accordance with the present invention may be understood fully with reference to the load indicating system 350 depicted in FIG. 3B. Load indicating system 350 comprises the load indicator plate system 300 affixed to a washer 100. As shown, bore holes 314 of the load indicator plate system 300 are positioned against bore holes 120 of washer 100 such that a suitable fastener 330 may be employed to immovably affix the indicator plate system 300 to the washer 100 front side surface 108. It should be understood that although washer 100 is depicted in FIG. 3B, indicator plate 302 may be employed with any suitable washer, or other fastener component, as described with reference to FIGS. 1A-B, 2A-D or the like. In addition, indicator plate system 300 may be attached to the suitable washer using any such fastening method capable of holding the indicator plate 302 immobile with respect to the washer 100 front side surface 108, such as, for example, screws, pins, rivets, or the like.

Indicator plate system 300 is affixed such that the adjustable screw 308 is positioned along the centerline 101 of the washer top surface 104. That is, adjustable screw 308 is positioned such that it is substantially equidistant between the left side surface 106 and right side surface 116, and is in continuous contact with the washer top surface 104. Prior to applying an axial load to the load indicating washer system, the adjustable screw 308 is adjusted such a that the screw 308 rests on the top surface of the washer 100. In this position, the deflection indicator 320 is calibrated such that the load indicating pointer 310 may point to 0% on the load indicating gauge 312 when the washer 100 is at a zero loading condition, and further point at the 100% load position when the washer 100 is at the washer's 100%, which indicates the fastener's proof load or fastener's breaking point or the point at which the fastener loses its viability.

As an axial load is applied to, or removed from, the load indicating washer system 350, the washer 100 experiences a deflection correlative to the amount of loading on the system. As the deflection occurs, elastic energy is stored in the washer 100 and the retention spring 306 contracts, causing the adjustable screw 308 to remain in contact with the deflecting washer top surface 104. Similarly, when the washer 100 is unloaded, the elastic energy is released, and the retention spring 306 expands, again causing the adjustable screw to remain in contact with the washer to surface 104. The contracting, or expanding, of retention spring 306 may further cause the main drive gear 304 to rotate about the main drive gear fastener 318. The rotation of the main drive gear 304 further causes the pinion gear 316 to rotate about the pinion gear fastener 322 which moves the load indicating pointer 310 in accordance with the amount of deflection caused by the axial loading. Upon loading or unloading of the washer 100, the load indicating pointer 310 adjusts with respect to the load indicating gauge 312 at a distance correlative to the percent loading or unloading of the washer 100. This, in turn, indicates to the user the amount of axial load presently on the fastener system 350 by positioning the pointer 310 along the load gauge 312 at a load percent location.

It should be understood that while the load indicating gauge 312 described in accordance with this invention uses a percent location correlation as a gauge reading, the invention is not to be so limited. For example, the load indicating gauge 312 of the present invention may use load indicating numbers which visually provide the actually loading presently being experienced by the washer load indicating system, or any such gauging system suitable for indicating load levels.

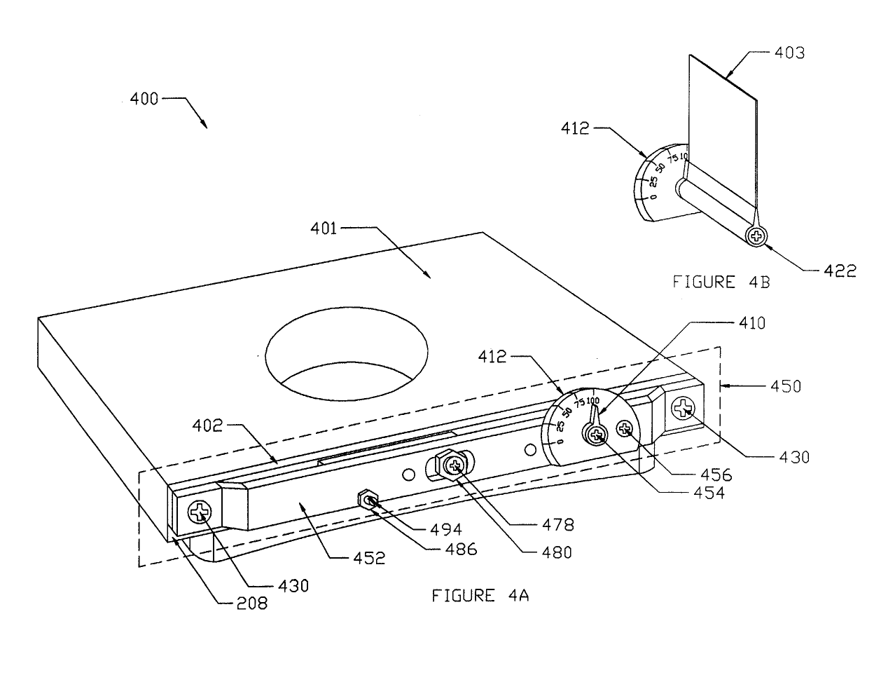

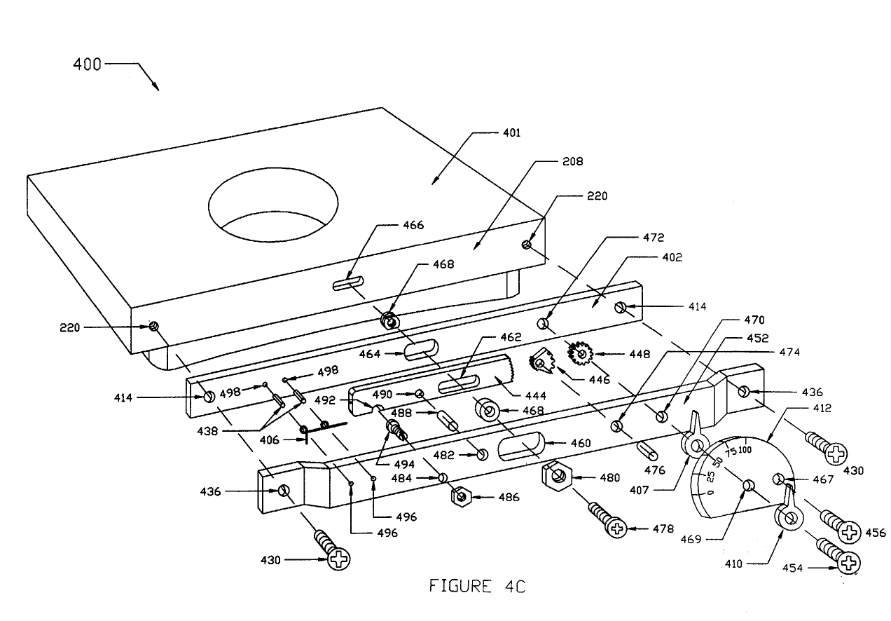

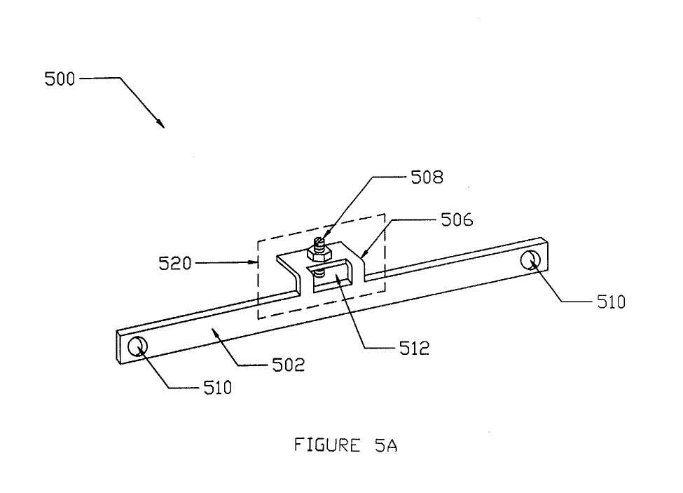

FIGS. 4A-4C depict another load indicating system 400 in accordance with an exemplary embodiment of the present invention, wherein a load indicating plate system 450 is depicted attached to a washer 401. It should be noted that washer 401 is of similar construction to washer 200 such that like elements 208 and 220 will have similar descriptions as like elements with respect to washer 200. It should also be noted, however, that washer 401 includes a front surface 208 including an elliptical shaped recess 466 positioned centrally to washer front surface 208. Further, it should be noted that while load indicating system 400 is described with respect to washer 401, the embodiment is not to be so limited. For example, load indicating system 400 may be described with respect to washer 100, 200 or any suitable variations thereof described above, wherein the washer additionally includes a recess of similar description as recess 466. As such, it is understood that the reference to washer 401 with respect to FIGS. 4A-4C is merely illustrative.

In this particular embodiment, load indicating plate system 450 is a multi-gear system configured to translate minimum washer dishing to a quantity readable with respect to a load indicator gauge 412. Load indicator plate system 450 is further configured with an outer bearing plate 452 for supporting and shielding the gears of plate system 450, thereby protecting the gears from dust and dirt and possible damage from outside forces. Consequently, load indicating plate system 450 may be preferable in loading environments where the washer 401 is of a robust construction (e.g., heavier grade material, giving to minimum dishing) or where the plate system 450 is in a harsher environment and is likely to be contacted during use.

As can be seen more fully with reference to FIG. 4C, load indicator plate system 450 (shown in exploded view) includes an inner plate 402 including bore holes 414, 498 and 472, where bore holes 414 are positioned at opposite ends of the inner plate 402, and are aligned with bore holes 220 of washer 401. Inner plate 402 further includes a slotted aperture 464 located centrally to inner plate 402 and aligned with washer recess 466.

Load indicator plate system 450 further includes an outer plate 452 having bore holes 436 positioned at opposite ends of the outer plate 452. The position of bore holes 436 is such that they may be aligned with bore holes 414, which, as noted, are further aligned with bore holes 220 of washer 401. In this arrangement, both the inner plate 402 and the outer plate 452 of the plate system 450 may be attached to washer 401 using suitable fasteners 430. The attachment of the inner plate 402 and the outer plate 452 to the washer 401 may be accomplished in the same manner as described above with respect to indicator plate 302. As such, the particular methods for attaching plates 402, 452 and the suitable fasteners 430 will not be repeated herein for brevity.

Outer plate 452 also includes an slotted aperture 460, aligned with aperture 464 of inner plate 402, which is further aligned with recess 466. Additionally, outer plate 452 includes bore holes 496 and a bore hole 470 respectively aligned with bore holes 498 and bore hole 472 of inner plate 402.

Interposed between inner plate 402 and outer plate 452 are a series of gears defined by a main drive gear 444, a combination gear 446, and a pinion gear 448. Main drive gear 444 includes an aperture 462 of similar size and shape as apertures 464 and 460 described above. Indeed, main drive gear 444 is positioned between the inner plate 402 and the outer plate 452 such that the main gear aperture 462 is aligned with both aperture 464 of inner plate 402, and with aperture 460 of outer plate 452, as well as, recess 466 of washer 401.

Main drive gear 444 further includes a bore hole 490 which may be aligned with bore hole 482 of outer plate 452, such that the main drive gear 444 may be held in place and allowed to rotate using a suitable fastener 488 such as a screw, pin or the like, where the fastener is positioned through both bore holes 490 and 482. Further, main drive gear 444 includes a semi-circular opening 492 which is aligned with bore hole 484 of outer surface 452. In this arrangement, a stop pin (e.g., screw, pin, rivet, or the like) 494 may be inserted in bore hole 484 such that the pin 494 will be fitted in the semi-circular opening 492, enabling the main drive gear to be seated firmly between inner plate 402 and outer plate 452, such that the end of the main drive gear 444 nearest the semi-circular opening 492 will be prohibited from protruding below the outer plate 452. The translational movement of the main drive gear 444 relative to the outer plate 452 may be further minimized by inserting a pin, rivet or screw 488 into bore hole 490 of the main drive gear 444 and bore hole 482 of the outer plate 452. Where a screw 494 is used, the screw may be immovably secured to outer plate 452 using a nut 486, as shown.

Positioned through apertures 460, 462, and 464 is a fastener 478, for providing main drive gear 444 with a fulcrum around which to rotate. Fastener 478 may be any suitable construction (e.g., screw, rivet, pin or the like) for allow main drive gear 444 to rotationally and/or translationally during use of the load indicating plate system 450. Indeed, where the fastener 478 is a screw, the screw 478 may be held in place using a suitable nut 480 into which the screw 478 may be fitted. Nut 480 may additionally be immovably fitted into aperture 460 to prevent translational movement of the screw 478. Further, the translational movement of the fastener 478 may be limited by spacers 468 positioned in aperture 462 of main drive gear 444, and in the aperture 464 of inner plate 402. Further still, the spacers 468 may be configured have an inner diameter greater than the outer diameter of fastener 478 allowing fastener 478 to freely rotate inside the spacers 468 bodies, as will be described more fully below.

Load indicator plate system 450 further includes a combination gear 446 including a central bore aligned with bore 474 of outer plate 452. Combination gear 446 is further positioned such that combination gear 446 is interlocked with main drive gear 444 allowing the rotation of main drive gear 444 to drive combination gear 446. Combination gear 446 may be held in place by a fastener 476 positioned through the combination gear 446 central bore, where fastener 476 may be a screw, pin, rivet, or the like.

In addition, load indicator plate system 450 also includes a pinion gear 448 including central bore aligned with bore 470 of outer plate 452 and bore 472 of inner plate 402. Pinion gear 448 is further positioned such that pinion gear 448 is interlocked combination gear 446 allow the rotation of the combination gear 446 to drive pinion gear 448. Pinion gear 448 may be held in place by a suitable fastener 454 positioned through the central bore of the pinion gear 448, where the fastener 454 may be any suitable screw, pin, rivet or the like.

Load indicator plate system 450 further includes a load indicating gauge 412 with a central bore 469 aligned with bore 470 of outer plate 452. Indicating gauge 412 includes a load indicating gauge as shown (e.g., 0%, 25%, 50%, 75%, and 100%), capable of indicating axial loading on washer 401. In the embodiment shown, gauge 412 may be affixed to outer plate 452 using suitable fasteners 454, and 456, where fastener 456 is inserted in gauge bore 467 and fastener 454 is inserted in gauge central bore 469. It should be understood that gauge 412 may have similar description as gauge 312 of FIG. 3A.

In addition, load indicator system 450 includes a load pointer 410 for indicating to a user the loading of the washer 401, by pointing to the loading position on gauge 412 in similar manner as was described with respect to indicating pointer 310 and scale 312. Load pointer 410 may be any construction useful for indicating to the user the appropriate axial load placed on washer 401, such as a the indicator depicted in FIGS. 4A and 4C or may be a flag pointer such as that pointer 403 shown in FIG. 4B. Load pointer 410 is movably affixed to gauge 412 using a fastener 454 inserted through the center of pointer 410, where the fastener 454 is additionally inserted through the bore 470 of outer plate 452, through the central bore of pinion gear 448, and through bore 472 of inner plate 472. Fastener 454 may be such that the outer diameter of fastener 454 is marginally larger than the diameter of central bore of pointer 410 and the central bore of pinion gear 448, and smaller that the inner diameter of gauge 412 central bore 469, bore 470 of outer plate 452, and bore 472 of inner plate 472. In this arrangement, pointer 410 is capable of rotating as pinion gear 448 rotates, relative to gauge 412.

Load indicator plate system 450 may further include an initial load set pointer 407 for indicating the initial loading condition of the washer 200. The load set pointer 407 may be affixed to gauge 412 in such a manner as to enable the system 450 user to fix the load set pointer 407 at the washer 200 initial loading level. For example, load set pointer 407 may include a central bore aligned with bore hole 469 of gauge 412, such that the load set pointer 407 is interposed between the gauge 412 and the outer plate 452, when gauge 412 is attached to outer plate 452. Load set pointer 407 may be held into place by fastener 454, in similar manner as is gauge 412, except that load set pointer 407 may be permitted to rotate around the axis of fastener 454. In this way, the user of system 450 can position load set pointer 407 at the initial load setting of washer 200.

It should be noted that the length of fastener 478 may be chosen such that the end of the fastener 478 opposite nut 480 its movably fitted into recess 466. With this construction, main drive gear is put in tacit communication with washer 401, such that the main drive gear 444 moves rotationally and translationally as washer 401 dishes under axial loading of the washer 401. As noted, the movement of main drive gear 444 drives combination gear 446, which, in turn, drives pinion gear 448. As noted, the movement of pinion gear 448 causes fastener 454 to rotate, which, in turn, moves pointer 410 along the gauge scale correlative to the amount of axial loading.

In some cases, the abutment of main drive gear 444 with combination gear 446 and, combination gear 446 with pinion gear 448 may not be perfect. That is, there may be marginal movement between the gearing arrangement such that the axial loading indicated on gauge 412 may not be entirely accurate. In this case, a spring 406 may be used to ensure that the interlocking of the gears 444, 446, and 448 remains snug. In particular, spring 406 may be positioned between inner plate 402 and outer plate 452 using a suitable fastener such as a pins 438, where pins 438 are fitted in bore holes 498 of inner plate 402 and 496 of outer plate 452, as shown. Spring 406 may further be attached to main drive gear 444 near pin 494 such that the elastic energy stored in spring 406 causes main drive gear 444 to exert rotational pressure on combination gear 446, which, in turn, causes combination gear 446, to exert rotational pressure on pinion gear 448. It should be understood, that in this configuration, the elastic energy stored in spring 406 will not be sufficient to force the gears 444, 446, and 448 to rotate. Instead, the elastic energy will be sufficient to ensure that the marginal movement which would otherwise develop between the gears is eliminated.

It should also be understood that structure of combination gear 446 may be chosen with respect to the expected dishing in washer 401, such that the gear ratio as measured from the main drive gear 444 to pinion gear 448 is sufficient to ensure movement of pointer 410 during operation of the load indicating system 400. For example, as shown, combination gear 446 is depicted having a small gear ratio between main drive gear 444 and combination gear 446, such that a small dishing experienced by washer 401 will translate into a larger rotation of pinion gear 448, since combination gear 446 is constructed with a smaller gear arrangement at gear 446 abutment with main drive gear 446 and a large gear arrangement at the abutment of gear 446 with pinion gear 448. This, in turn, will allow a small dishing of gear 401 to be translated into a measurable axial loading quantity at pointer 410. Such gear structures are commonly known. As such, the operation of combination gear 446 will not be discussed herein in detail.

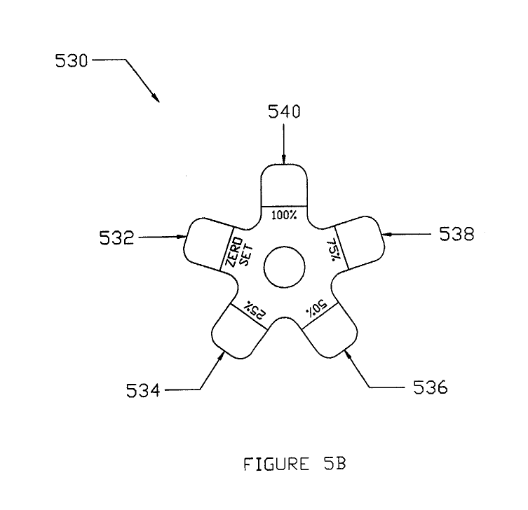

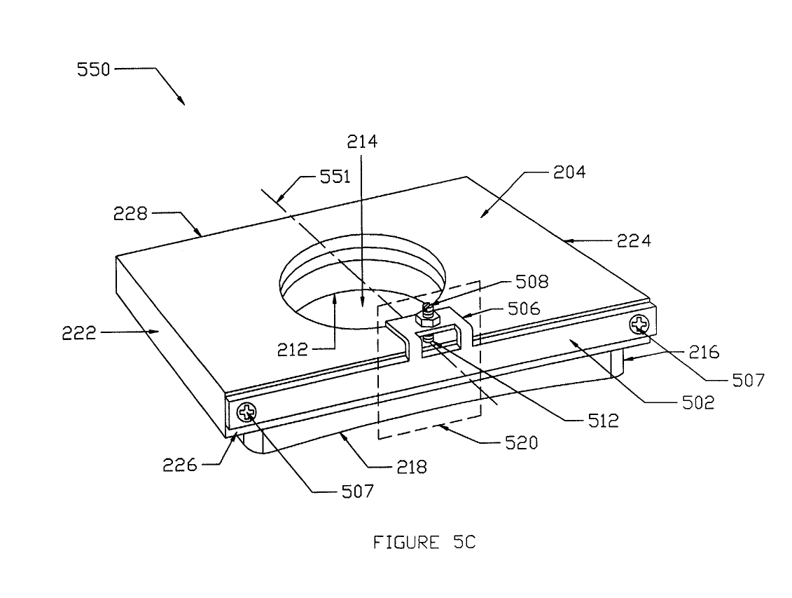

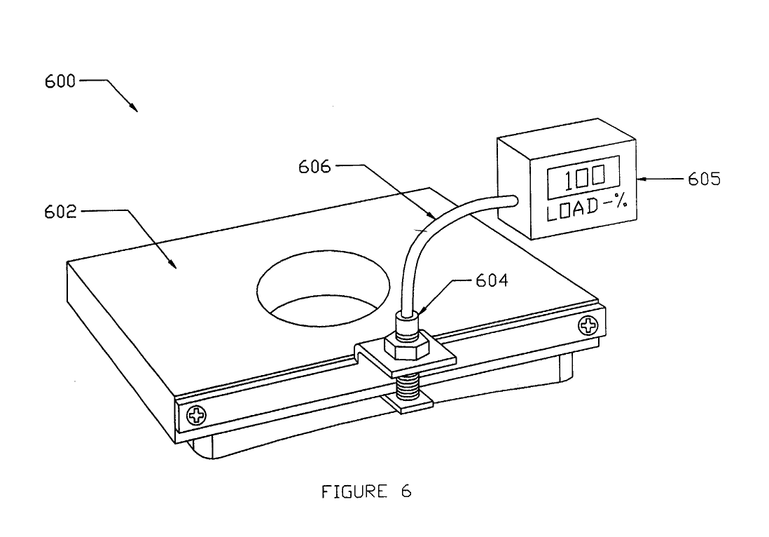

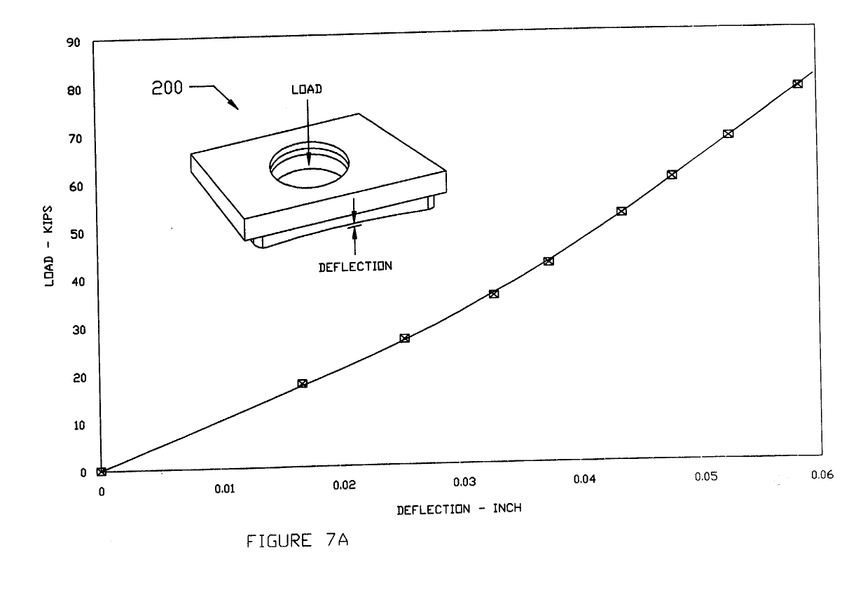

FIG. 5A depicts another exemplary embodiment of a load indicating system 500 in accordance with the present invention. Load indicating system 500 is described with respect to washer 200, although it should be understood that the system 500 may be described with respect to any variation of the washers described herein.

As shown, load indicating system 500 may include a load indicating plate 502 and a deflection indicator 520. Load indicating plate 502 may further include bore holes 510 at opposing ends of the indicator plate 502 for accepting a fastener for affixing the indicator plate to a washer (not shown). Deflection indicator 520 may be immovably affixed to indicator plate 502, or may be formed as a projection emanating from the indicator plate 502 body as shown. In addition, deflection indicator 520 may comprise an adjustable screw 508 inserted in the deflection indicator 520 such that the screw may be positioned perpendicularly to the surface 204 of a washer in accordance with the present invention. Further, deflection indicator 520 may include an opening 512 suitably configured to allow visual and physical access to adjustable screw 508.

FIG. 5B depicts an exemplary feeler gauge 530 in accordance with the present invention. As shown, feeler gauge 530 may include feeler tabs 532, 535, 536, 538 and 550 of varying thickness, where each level of thickness corresponds to the measure of deflection, e.g., the load, experienced by a washer 200. Further, the width of feeler tabs 532, 535, 536, 538 and 550 are such that each tab may be inserted into opening 512 during operation of the load indicating plate system 550 (shown in FIG. 5C). In addition, each feeler tab may be employed to indicate the percentage of deflection experienced by the washer 200, as shown, where 0% indicates that the washer 200 is experiencing no axial loading and 100% indicates that the washer 200 is at its breaking point or that the fastener integrity has been compromised.

It should be understood that while the feeler gauge 530 described in accordance with this invention uses a percent correlation to axial loading as a gauge reading, the invention is not to be so limited. For example, the feeler gauge 530 of the present invention may use load indicating numbers which visually provide the actually loading presently being experienced by the washer load indicating system 550, or any such similar indication of load. In addition, while feeler gauge 530 is depicted with five feeler tabs, it should be understood that the invention is not to be so limited. For example, feeler gauge 530 may include more feeler tabs, such as when it may be necessary to provide axial loading to the washer 200 in more graduated levels. For example, in the case where ten feeler tabs are employed, the feeler tabs may be configured to indicate axial loading of 10%, 20%, 30%, 40%, 50%, 60%, 70%, 80%, 90% and 100% as required. Conversely, feeler gauge 530 may include less feeler tabs, such as when it may be necessary to determine the axial loading of the feeler tabs at less graduated levels. For example, feeler gauge 530 may include four feeler tabs, where the feeler tabs may be used to indicate an axial loading of 0%, 33%, 66%, and 99%. In this embodiment, 0% may indicate no axial loading of the washer 100, 200 and 99% may indicate that the washer 200 has reached its critical effective loading level (e.g., proof load or breaking point or loss of integrity).

The operation of the load indicating washer system 550 may be understood fully with reference to FIG. 5C, where the system comprises the load indicator plate system 500 shown affixed to a washer 200. As shown, bore holes 510 of the load indicator plate system 500 are positioned against bore holes 220 of washer 200 such that suitable fasteners 507 may be employed to immovably affix the indicator plate system 500 to the washer 200 front side surface 226. It should be understood that indicator plate system 500 may be attached to the suitable washer 200 using any such fastening method capable of holding the indicator plate 502 immobile with respect to the washer 200 front side surface 226.

Indicator plate system 500 is affixed such that the adjustable screw 508 is positioned along the centerline 551 of the washer top surface 204. That is, adjustable screw 508 is positioned such that it is substantially equidistant between the left side surface 222 and right side surface 224. Prior to applying an axial load to the load indicating washer system, feeler tab 532 of feeler gauge 530 may be placed into opening 512, and more particularly, under the bottom portion of adjustable screw 508 and onto the surface of washer 200. The adjustable screw 508 may then be adjusted so that it comes to rest on top of feeler tab 532, which, in turn, allows calibration of the load indicating system 500 at zero load condition. In this position, a measurable gap is created between the adjustable screw 508 and the washer upper surface 204 and the load indicator 520 is calibrated such that the feeler tab 532 when inserted into the measurable gap as described above, indicates that the washer 200 is experiencing 0% load.

As an axial load is applied to, or removed from the load indicating washer system 550, the washer 200 experiences a deflection correlative to the amount of loading on the system. This deflection, in turn, causes the washer 200 to store elastic energy and further causes the measurable gap to increase or decrease in accordance with the amount of axial load. The amount of desired increase or decrease in axial load can then be accurately determined using feeler tabs 535, 536, 538, 550 in similar manner as was described above with respect to feeler tab 532. More particularly, the axial load may then be increased or decreased to a desired load as measured by the feeler tabs of feeler gauge 530. For example, where a 50% load condition is desired, the axial load may be increased on the washer until feeler tab 536 fits into opening 512 such that adjustable screw 508 rest on the surface of the feeler tab 536, and the feeler tab 536 rests on the washer 200 upper surface 204. In addition, it should be noted that under this configuration, 100% load may be measured by inserting feeler tab 540 in like manner as was done with respect to feeler tab 536. In this case, feeler tab 540 may represent the breaking point or the point where the fastener may not be viable. In the alternative, 100% load may represent any load desired by the system user.

In yet another exemplary embodiment of the present invention, a load indicator system 600 may incorporate a transducer 604 capable of detecting the deflection of a washer 602 may be used. A suitable transducer for use with the is embodiment may be a LVDT or SPC4 displacement transducer, or the like, as is commonly known. As shown, washer system 600 may be of similar construction and operation as washer system 500 described with respect to FIGS. 5A-5C. Instead of utilizing an adjustable screw 508, however, system 600 uses a deflection transducer capable of converting the washer 602 deflection into a signal readable by an externally situated electrical component (not shown). The washer 602 deflection is converted into an electrical signal representative of the total deflection experienced by the system 600. The electrical component may receive the signal through a cable 606, wherein the signal is converted to an electrical output correlative to the loading experienced by the system 600, which is readable by the system 600 user. It should be noted, that while system 600 is described with respect to an electrical output, the invention is not to be so limited. For example, the transducer 604 may convert the detected deflection into a signal which may be sent to any suitable output device for displaying the deflection in a form readable by the system 600 user.

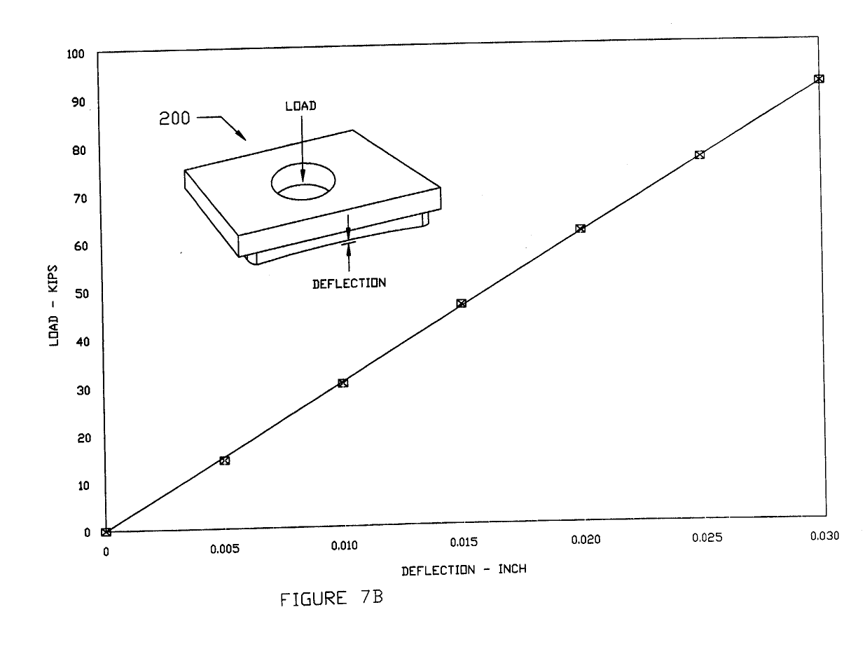

As noted, the spherical bottom portion 118 and 218 of washer 100 and 200 deflects proportionately to the applied load, which in turn, causes the upper surface of the washer 100, 200 to deflect correlatively and further causes the washer to store elastic energy. Given the proportionality between the deflection and the applied load, the dimensional features of the washer (thickness and radius of the bottom surface 118 and 218) may be controlled so that at a certain deflection of the spherical surface 118, 218, a desired load condition can be achieved increasing the viability of a fastener arrangement. In one particular embodiment, the washer 200 may be designed so that the maximum load e.g., 100% load represents the proof load of the fastener used to apply the axial load to the washer 200. For example, with reference to FIG. 7A, what is shown is an exemplary load-deflection relationship of a typical joint using a 4 inch by 5 inch washer 200 with a 80,000 lbs. capacity and a 1-½ inch bolt at a 4 inch grip length. Where a 4 inch by 5 inch washer 200 has a load capacity of 80,000 lbs., the spherical surface 218 may typically be configured such that a deflection of 0.060 inches is measured in the washer 200 at 80 KIPS. This elastic energy given to the washer deflection may be added to the elastic energy stored in the typical joint arrangement not using such a washer 200, which may ordinarily experience a deflection of 0.006 inches. In this case, when the deflection of washer 200 is added to the ordinary deflection of the join, the joint will experience a total deflection of 0.066 inches, since the energy given to the deflection of the washer 200 may now be added to the elastic energy stored in the bolt. In this case, a 1000% increase in stored elastic energy is evident, which increases the viability of the joint. That is, the joint becomes 10 times more tolerant to in-service loosing or failure.

In FIG. 7B, what is shown is an exemplary load-deflection relationship of a typical joint using a 5 inch by 5.7 inch washer 200 with a 90,000 lbs. capacity and a 1-½ inch bolt at a 4 inch grip length. Where a 5 inch by 5.7 inch washer 200 has a load capacity of 90,000 lbs., the spherical surface 218 may typically be configured such that a deflection of 0.030″ is measured in the washer 200 at 90 KIPS. This elastic energy given to the washer 200 deflection may be added to the elastic energy stored in the typical joint arrangement not using such a washer 200, which may ordinarily experience a deflection of 0.007 inches. In this case, when the deflection of washer 200 is added to the ordinary deflection of the joint, the joint will experience a total deflection of 0.037 inches, since the energy given to the deflection of the washer 200 may now be added to the elastic energy stored in the bolt. In this case, a 430% increase in stored elastic energy is evident, which increases the viability of the join. That is, the joint becomes 5.3 times more tolerant to in-service loosing or failure.

The present invention has been described above with reference to various exemplary embodiments. However, those skilled in the art will recognize that changes and modifications may be made to the exemplary embodiments without departing from the scope of the present invention. For example, central bore of the washers described above may be configured to accommodate any apparatus for fastening or sealing. That is, where a rectangular seal is to be inserted into the central bore location, the washer recess may be configured to accommodate such rectangular seal. Similarly, where a circular seal is to be used with respect to the bottom surface of the washer the bottom surface may be configured such that the circular seal may be inserted around the perimeter of the bottom surface. In the alternative, the washer may be configured such that only one seal or no seals are use. Further, the washer bottom may be formed with or without the use of serrations as required. Further still, while the present invention has been described with respect to fasteners such as an adjustable screw, it should be understood that any suitable adjustable member performing the function of the adjustable screw may be used and are well known in the fastener art. Consequently, such adjustable members are not discussed herein for brevity. Further, while the invention has been described with respect to fasteners, it should be understood that any such member capable of performing a fastening function as variously described herein may be used. In addition, other gauges, transducers, and the like incorporating external electrical components may be used. These and other changes or modifications are intended to be included within the scope of the present invention, as set forth in the following claims.

We claim:

1. A load indicating system for use with fasteners experiencing axial loading, comprising:
a fastener insert for including in a fastener joint, said fastener insert comprising an upper insert surface, a front insert surface and a rear insert surface, said front insert surface and said rear insert surface formed perpendicular to said upper insert surface, and a bottom insert surface substantially parallel to said upper insert surface, said bottom insert surface including an arc, said arc formed from said front insert surface to said rear insert surface, said arc positioned to provide for insert deflection during axial loading; and
a load indicator plate system affixed to said front insert surface.

2. A load indicating system according to claim 1 wherein, said load indicator plate system further comprises:
an indicator plate having a first and second opposing ends; and
a deflection indicator positioned substantially equidistant between said first and second opposing ends.

3. A load indicating system according to claim 2 wherein, said deflection indicator further comprises:
a load indicating gauge attached to said indicator plate, said indicating gauge positioned between said first and second opposing ends, said load indicating gauge comprising visible indications of insert load levels, said load indicating gauge characterized by an indicating gauge central axis;
a load indicating pointer rotatably attached along said indicating gauge central axis, said indicating pointer for pointing to said visual indications of insert levels in accordance with said insert deflection during axial loading;
a pinion drive gear rotatably attached to said indicator plate, said pinion drive gear immovably fixed to said load indicating pointer;
a main drive gear rotatably attached to said load indicator plate and interlocked with said pinion drive gear, said main drive gear being positioned to rotate against said pinion drive gear causing said pinion drive gear to rotate, said main drive gear comprising an adjustable screw, said adjustable screw positioned to abut against said insert upper surface; and
a retention spring comprising a first spring end and a second spring end, said first spring end attached to said main drive gear and said second spring end attached to said load indicator plate for ensuring continuous abutment of said adjustable screw to said upper insert surface during said axial loading.

4. A load indicating system according to claim 1 wherein, said load indicator plate system comprises:
an indicator plate having a first and second opposing ends;
a load indicating gauge attached to said indicator plate, said indicating gauge positioned between said first and second opposing ends, said load indicating gauge comprising visible indications of insert load levels, said load indicating gauge characterized by an indicating gauge central axis;
a load indicating pointer rotatably attached along said indicating gauge central axis, said indicating pointer for pointing to said visual indications of insert levels in accordance with said insert deflection during axial loading;
a pinion drive gear rotatably attached to said indicator plate, said pinion drive gear immovably fixed to said load indicating pointer;
at least a middle drive gear interlocked with said pinion gear, said middle drive gear positioned to rotate against said pinion drive gear causing said pinion drive gear to rotate; and
a main drive gear rotatably attached to said load indicator plate and interlocked with said middle drive gear, said main drive gear being positioned to rotate against said middle drive gear causing said middle drive gear to rotate, said main drive gear in tacit communication with said front insert surface.

5. A load indicating system according to claim 4, further comprising a retention spring, for ensuring continuous abutment of said main drive gear with said middle drive gear.

6. A load indicating system according to claim 2 wherein said deflection indicator
comprises an adjustable screw positioned substantially perpendicular to said upper insert surface; and
an opening for providing physical access to said adjustable screw.

7. A load indicating system according to claim 6 further comprising a load indicating feeler gauge for use in determining insert axial loading, said feeler gauge comprising at least one feeler tab for inserting between said adjustable member and said upper insert surface.

8. A load indicating system according to claim 2 wherein, said deflection indicator comprises a transducer for translating said axial loading to an electrical signal.

9. A load indicating system according to claim 8 further comprising an electrical component for receiving said transducer signal and providing a visual reading correlative to at least one of load indicating system axial loading and insert deflection.

10. A load indicating system according to claim 8 wherein said transducer is at least one of a displacement transducer and pressure transducer.

11. A load indicating system according to claim 1 wherein said insert stores elastic energy correlative to said insert deflection.

12. A load indicating system for use with fasteners experiencing axial loading, comprising:
a fastener insert for including in a fastener joint, said fastener insert comprising:
an upper insert surface;
a front insert surface
a rear insert surface; and
a bottom insert surface substantially parallel to said upper insert surface, said bottom insert surface including an arc, said arc formed from said front insert surface to said rear insert surface, said arc positioned to provide for insert deflection during axial loading.

13. A load indicating system according to claim 12 further comprising:
a load indicator plate system affixed to said front insert surface, said load indicator plate system further comprising:
an indicator plate having a first and second opposing ends; and
a deflection indicator positioned substantially equidistant between said first and second opposing ends.

14. A load indicating system according to claim 13 wherein, said deflection indicator further comprises:
a load indicating gauge attached to said indicator plate, said indicating gauge positioned between said first and second opposing ends, said load indicating gauge comprising visible indications of insert load levels, said load indicating gauge characterized by an indicating gauge central axis;
a load indicating pointer rotatably attached along said indicating gauge central axis, said indicating pointer for pointing to said visual indications of insert levels in accordance with said insert deflection during axial loading;
a pinion drive gear rotatably attached to said indicator plate, said pinion drive gear immovably fixed to said load indicating pointer;
a main drive gear rotatably attached to said load indicator plate and interlocked with said pinion drive gear, said main drive gear being positioned to rotate against said pinion drive gear causing said pinion drive gear to rotate, said main drive gear comprising an adjustable screw, said adjustable screw positioned to abut against said insert upper surface; and
a retention spring comprising a first spring end and a second spring end, said first spring end attached to said main drive gear and said second spring end attached to said load indicator plate for ensuring continuous abutment of said adjustable screw to said upper insert surface during said axial loading.

15. A load indicating system according to claim 12 wherein, said load indicator plate system comprises:
an indicator plate having a first and second opposing ends;
a load indicating gauge attached to said indicator plate, said indicating gauge positioned between said first and second opposing ends, said load indicating gauge comprising visible indications of insert load levels, said load indicating gauge characterized by an indicating gauge central axis;
a load indicating pointer rotatably attached along said indicating gauge central axis, said indicating pointer for pointing to said visual indications of insert levels in accordance with said insert deflection during axial loading;
a pinion drive gear rotatably attached to said indicator plate, said pinion drive gear immovably fixed to said load indicating pointer;
at least a middle drive gear interlocked with said pinion gear, said middle drive gear positioned to rotate against said pinion drive gear causing said pinion drive gear to rotate; and
a main drive gear rotatably attached to said load indicator plate and interlocked with said middle drive gear, said main drive gear being positioned to rotate against said middle drive gear causing said middle drive gear to rotate, said main drive gear in tacit communication with said front insert surface.

16. A load indicating system according to claim 1S, further comprising a retention spring, for ensuring continuous abutment of said main drive gear with said middle drive gear.

17. A load indicating system according to claim 13 wherein said deflection indicator
comprises an adjustable screw positioned substantially perpendicular to said upper insert surface; and
an opening for providing physical access to said adjustable screw.

18. A load indicating system according to claim 17 further comprising a load indicating feeler gauge for use in determining insert axial loading, said feeler gauge comprising at least one feeler tab for inserting between said adjustable member and said upper insert surface.

19. A load indicating system according to claim 13 wherein, said deflection indicator comprises a transducer for translating said axial loading to an electrical signal.

20. A load indicating system according to claim 19 further comprising an electrical component for receiving said transducer signal and providing a visual reading correlative to at least one of load indicating system axial loading and insert deflection.

21. A load indicating system according to claim 19 wherein said transducer is at least one of a displacement transducer and pressure transducer.

22. A load indicating system according to claim 12 wherein said insert stores elastic energy in accordance with insert deflection.

23. A method for measuring insert axial loading comprising:
providing a fastener insert with an upper insert surface, the fastener insert further comprising a bottom insert surface including an arc for ensuring insert deflection during axial loading,
providing a load indicating system affixed to the insert, the load indicating system configured to provide visual indication of the level of axial loading of the insert.

24. A method according to claim 23 further comprising the steps of
providing a load indicating gauge;
providing a pinion gear including a load indicating pointer for indicating axial load levels of the insert in accordance with the load indicating scale,
providing a main drive gear for driving the pinion gear in accordance with the insert axial loading, the main drive gear including an adjustable member for abutting against the upper insert surface during axial loading; and
providing a retention spring attached to the main drive gear for ensuring continuous abutment of the adjustable member to the upper insert surface during axial loading.

25. A method according to claim 23 further comprising the steps of:
providing a load indicating system including an adjustable member positioned substantially perpendicular to the upper insert surface and an opening for access to the adjustable member,
providing a load indicating feeler gauge for identifying the axial load level, the feeler gauge including a multiplicity of feeler tabs being configured to be positioned in the opening and between adjustable member and the upper insert surface,
adjusting the adjustable member to determine the zero load position of the insert, and further using at least one of the multiplicity of feeler tabs to determine axial loading level during axial loading of the insert.

26. A method according to claim 23 further including the step of providing an insert configured to store elastic energy, the storage of elastic energy correlative to the deflection of the insert.

27. A method according to claim 23 further comprising the steps of:
providing a load indicating gauge;
providing a pinion gear including a load indicating pointer for indicating axial load levels of the insert in accordance with the load indicating scale, providing at least a middle gear for driving the pinion gear;
providing a main drive gear for driving the middle gear in accordance with the insert axial loading, the main drive gear including an adjustable member for abutting against the upper insert surface during axial loading; and
providing a retention spring attached to the main drive gear for ensuring continuous abutment of the adjustable member to the upper insert surface during axial loading.

28. A method according to claim 23 further including the steps of:
providing a transducer for translating the axial loading of the insert into a signal correlative to the insert axial loading; and
providing an external device for translating the signal into a readable output correlative of axial loading.

29. A method for measuring insert axial loading comprising:
providing a fastener insert with an upper insert surface, the fastener insert further comprising a bottom insert surface including an arc for ensuring insert deflection during axial loading.

30. A method according to claim 29 further comprising the steps of
providing a load indicating system affixed to the insert, the load indicating system configured to provide visual indication of the level of axial loading of the insert
providing a load indicating gauge
providing a pinion gear including a load indicating pointer for indicating axial load levels of the insert in accordance with the load indicating scale,
providing a main drive gear for driving the pinion gear in accordance with the insert axial loading, the main drive gear including an adjustable member for abutting against the upper insert surface during axial loading, and
providing a retention spring attached to the main drive gear for ensuring continuous abutment of the adjustable member to the upper insert surface during axial loading.

31. A method according to claim 29 further comprising the steps of:
providing a load indicating system including an adjustable member positioned substantially perpendicular to the upper insert surface and an opening for access to the adjustable member,
providing a load indicating feeler gauge for identifying the axial load level, the feeler gauge including a multiplicity of feeler tabs being configured to be positioned in the opening and between adjustable member and the upper insert surface,
adjusting the adjustable member to determine the zero load position of the insert, and further using at least one of the multiplicity of feeler tabs to determine axial loading level during axial loading of the insert.

32. A method according to claim 29 further including the step of providing an insert configured to store elastic energy, the storage of elastic energy correlative to the deflection of the insert.

33. A method according to claim 29 further comprising the steps of:
providing a load indicating gauge;
providing a pinion gear including a load indicating pointer for indicating axial load levels of the insert in accordance with the load indicating scale,
providing at least a middle gear for driving the pinion gear;
providing a main drive gear for driving the middle gear in accordance with the insert axial loading, the main drive gear including an adjustable member for abutting against the upper insert surface during axial loading; and
providing a retention spring attached to the main drive gear for ensuring continuous abutment of the adjustable member to the upper insert surface during axial loading.

34. A method according to claim 29 further including the steps of:
providing a transducer for translating the axial loading of the insert into a signal correlative to the insert axial loading; and
providing an external device for translating the signal into a readable output correlative of axial loading.
